(19) United States
(12) Patent Application Publication
(10) Pub. No.: US 2009/0039720 A1
(43) Pub. Date: Feb. 12, 2009

(54) TERMINAL MODULE FOR ROTATING ELECTRIC MACHINE, AND ROTATING ELECTRIC MACHINE

(75) Inventors: Hiroyuki Tsukashima, Aichi-ken (JP); Sho Miyazaki, Mie-ken (JP)

Correspondence Address: SUGHRUE MION, PLLC, 2100 PENNSYLVANIA AVENUE, N.W., SUITE 800, WASHINGTON, DC, 20037, US

(73) Assignees: TOYOTA JIDOSHA KABUSHIKI KAISHA, Toyota-shi (JP); AUTONETWORKS TECHNOLOGIES, LTD., YOKKAICHI-SHI (JP); SUMITOMO WIRING SYSTEMS, LTD., YOKKAICHI-SHI (JP); SUMITOMO ELECTRIC INDUSTRIES, LTD., OSAKA-SHI (JP)

(21) Appl. No.: 12/282,948

(22) PCT Filed: Mar. 16, 2007
(86) PCT No.: PCT/JP2007/056133

§ 371 Date: Sep. 15, 2008

(30) Foreign Application Priority Data
Mar. 29, 2006 (JP) 2006-090430

(51) Int. Cl. H02K 11/00

(52) U.S. Cl. 310/71

(57) ABSTRACT

A terminal module for a rotating electric machine, allowing automatic assembling, is provided. The terminal module for a rotating electric machine includes a polygonal rail (100) provided with a groove, and a polygonal bus bar fitted in the groove.

### TECHNICAL FIELD

The present invention relates to a terminal module for a rotating electric machine, and a rotating electric machine. More particularly, the present invention relates to a terminal module for a rotating electric machine having a cassette coil of concentrated winding attached, and a rotating electric machine utilizing the same.

### BACKGROUND ART

Conventional rotating electric machines are disclosed in, for example, Japanese Patent Laying-Open Nos. 2003-284279 (Patent Document 1), 2004-242472 (Patent Document 2), and 9-322459 (Patent Document 3).

### DISCLOSURE OF THE INVENTION

Patent Document 1 discloses a collecting/distributing ring having three bus bars integrated in annular form, bundling external connection terminals.

Patent Document 2 discloses a conductive path having bus bars with electric line terminals molded with resin, facilitating connection of the electric wires of a motor. In addition, integration of the connector for the electric wires is taught.

Patent Document 3 discloses the approach of gathering the terminal lines from a stator coil at a distributing board for connection.

These conventional approaches are disadvantageous in that automatic assembling is difficult when the collecting/distributing ring is circular in shape due to the poor machining accuracy.

In view of the foregoing, an object of the present invention is to provide a terminal module for a rotating electric machine, facilitating automatic assembling.

A terminal module for a rotating electric machine according to the present invention includes a rail of a polygonal shape, having a groove extending in the circumferential direction, and a bus bar of a polygonal shape, fitted in the groove. A terminal module for a rotating electric machine configured as set forth above can be formed in favorable accuracy due to the rail and bus bar both taking a polygonal shape, as compared to a circular shape. Accordingly, the accuracy of the rail and bus bar is improved, allowing automatic assembling. Therefore, the cost can be reduced and mass production allowed.

In the case of combination with a motor such as of the concentrated winding type, the space at the back yoke of the coil is used efficiently to allow downsizing of the motor per se.

Preferably, the plurality of grooves are arranged spaced apart in the radial direction of the polygonal shape.

Preferably, the thickness direction of the bus bar corresponds to the radial direction of the polygonal shape.

Preferably, the bus bar includes a terminal extending in the axial direction of the polygonal shape, and connected to the coil.

Preferably, a rib abutting against the bus bar to push the bus bar in the radial direction of the polygonal shape is provided at the groove. In this case, the fixed accuracy of the bus bar is improved by the pressure of the rib, allowing improvement in the accuracy in automatic assembling.

Preferably, the terminal module further includes a connector provided at the rail. Since the position of the connector is maintained, the accuracy in automatic assembling is improved. Moreover, the sealing in resin molding of the motor is facilitated.

Preferably, a flat face abutting against a cassette coil is provided at the inner circumferential face of the rail.

A rotating electric machine of the present invention includes the terminal module set forth above, a cassette coil of concentrated winding abutting against the flat face of the rail, and a mold member for molding the rail and cassette coil.

The rotating electric machine based on the configuration set forth above can be fabricated through simple steps by automatic assembling of a cassette coil with the terminal module, followed by molding.

According to the present invention, there can be provided a terminal module for a rotating electric machine, facilitated in automatic assembling, and a rotating electric machine using said terminal module.

### BRIEF DESCRIPTION OF THE DRAWINGS

FIG. 1 is a perspective view of a terminal module for a rotating electric machine according to the present invention.

FIG. 2 is an exploded perspective view of a terminal module for a rotating electric machine according to the present invention.

FIG. 3 is a plan view of a rail partially enlarged.

FIG. 4 is a sectional view taken along arrow IV-IV in FIG. 3.

FIG. 5 is a plan view of a rail according to another aspect.

FIG. 6 is a sectional view taken along arrow VI-VI of FIG. 5.

FIG. 7 is a perspective view of a portion of a rail.

FIG. 8 is a perspective view of a connector.

FIG. 9 is a perspective view of a stator employing a terminal module of the present invention.

FIG. 10 is a perspective view of a stator molded by a mold member.

### BEST MODE FOR CARRYING OUT THE INVENTION

Embodiments of the present invention will be described hereinafter with reference to the drawings. In the embodiments, the same or corresponding elements have the same reference characters allotted, and description thereof will not be repeated.

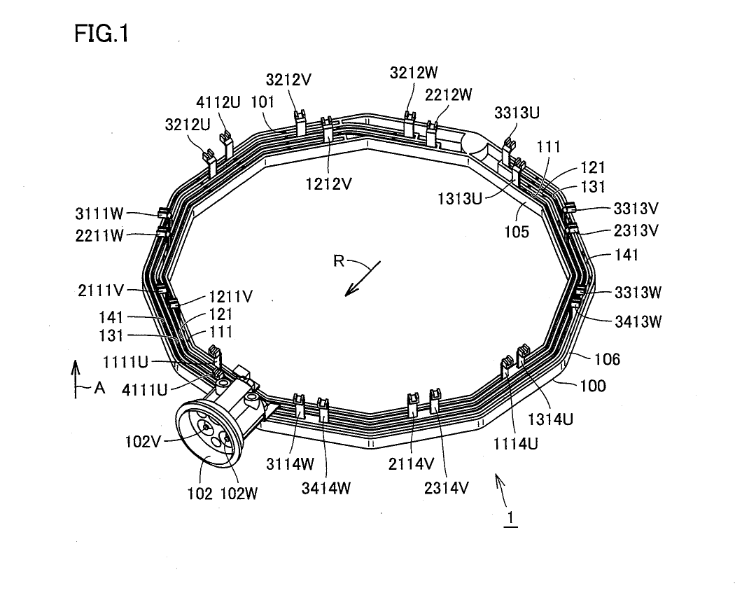

FIG. 1 is a perspective view of a terminal module for a rotating electric machine according to the present invention. Referring to FIG. 1, a terminal module 1 for a rotating electric machine includes a rail 100. Rail 100 takes a ring (annular) shape of a regular dodecagon, formed to surround a predetermined space. The shape of rail 100 is not limited to a dodecagon, and may take any other polygonal shape. The shape of rail 100 is determined based on the number of cassette coils arranged in rail 100.

Rail 100 includes an inner circumferential face 105 and an outer circumferential face 106. Both of inner and outer circumferential faces 105 and 106 are flat. Inner circumferential face 105 and outer circumferential face 106 are located at the inner circumferential side and outer circumferential side, respectively, of rail 100, extending circumferentially of rail 100.

A plurality of grooves 111, 121, 131, and 141 are provided at rail 100.

Groove 111 is located at the innermost side, in which a plurality of bus bars are fitted.

Second groove 121 is arranged at the outer circumferential side of groove 111. Second groove 121 is arranged along and parallel to first groove 111.

Third groove 131 is located at the outer side of second groove 121, arranged along and parallel to second groove 121.

Fourth groove 141 is located at the outer side of third groove 131, arranged along and parallel to third groove 131.

A plurality of bus bars are fitted in first groove 111 to fourth groove 141. A coil terminal extends from the bus bar so as to extend in the axial direction indicated by arrow A. First U-phase coil terminals 1111U and 4111U, serving as electrodes for the U-phase, are fitted in first groove 111 and fourth 141, respectively.

First V-phase coil terminals 1211V and 2111V are fitted in first groove 111 and second groove 121, respectively. First W-phase coil terminals 2211W and 3111W are fitted in second groove 121 and third groove 131, respectively.

Second U-phase coil terminals 3212U and 4112U are fitted in third groove 131 and fourth groove 141, respectively. Second V-phase coil terminals 3212V and 1212V are fitted in third groove 131 and first groove 111, respectively. Second W-phase coil terminals 3212W and 2212W are fitted in third groove 131 and second groove 121, respectively.

Third U-phase coil terminals 3313U and 1313U are fitted in third groove 131 and first groove 111.

Third V-phase coil terminals 3313V and 2313V are fitted in third groove 131 and second groove 121.

Third U-phase coil terminals 3313W and 3413W are fitted in third groove 131.

Fourth U-phase coil terminals 1314U and 1114U are fitted in first groove 111. Fourth V-phase coil terminals 2314V and 2114V are fitted in second groove 121. Fourth W-phase coil terminals 3414W and 3114W are fitted in third groove 131. The arrangement of which terminal is to be fitted in a certain groove is not particularly limited, as long as they are arranged to connect the U-phase, V-phase and W-phase coils for the operation of a rotating electric machine.

A connector 102 constituting a terminal is provided at rail 100. A metal terminal provided in connector 102 is connected to each bus bar. The U-phase, V-phase and W-phase coil terminals extend in an orthogonal direction with respect to the radial direction of the polygon indicated by arrow R.

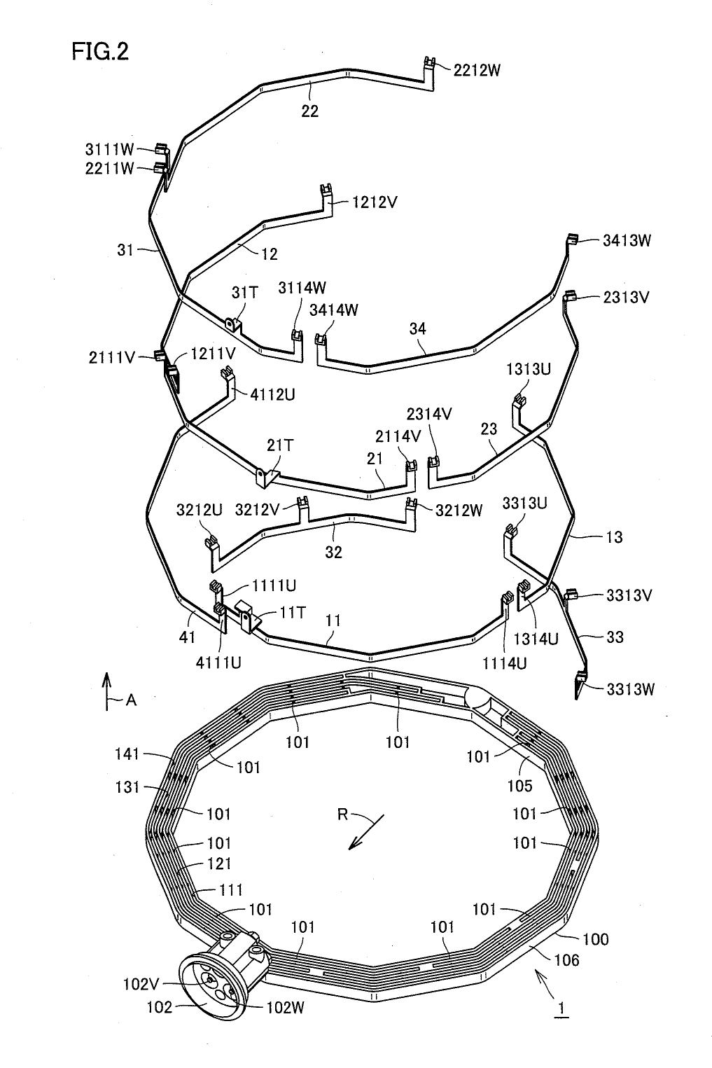

FIG. 2 is an exploded perspective view of a terminal module for a rotating electric machine according to the present invention. Referring to FIG. 2, rail 100 includes first groove 111, second groove 121, third groove 131, and fourth groove 141 in annular shape. Each groove is formed interrupted in the course of its extension. A rib 101 to secure the bus bar is provided at first groove 111, second groove 121, third groove 131 and fourth groove 141. Rib 101 is configured to extend in the axial direction of the polygonal shape (the direction indicated by arrow A). Although at least one rib 101 is provided at one of the sides of the polygon, the present invention is not limited thereto, and rib 101 may be absent from any of the sides. Rib 101 does not have to be provided at all the sides. When rib 101 is to be provided, at least two ribs 101 are preferably provided per side to ensure pushing against the bus bar.

First bus bars 11, 12 and 13 are fitted in first groove 111. First U-phase coil terminal 1111U and fourth U-phase coil terminal 1114U are provided at first bus bar 11. A connector terminal 11T is attached to first bus bar 11. Power is supplied from connector terminal 11T, which is delivered to first bus bar 11.

First bus bar 12 is fitted in first groove 111. First V-phase coil terminal 1211V and second V-phase coil terminal 1212V are provided at first bus bar 12. First bus bar 13 is fitted in first groove 111. Third U-phase coil terminal 1313U and fourth U-phase coil terminal 1314U are provided at first bus bar 13.

Second bus bar 21 is fitted in second groove 121. First V-phase coil terminal 2111V and fourth V-phase coil terminal 2114V are provided at second bus bar 21. Connector terminal 21T is provided at second bus bar 21. Connector terminal 21T is connected to connector 102. Second bus bar 22 is fitted in second groove 121. First W-phase coil terminal 2211W and second W-phase coil terminal 2212W are provided at second bus bar 22. Second bus bar 23 is fitted in second groove 121. Third V-phase coil terminal 2313V and fourth V-phase coil terminal 2314V are provided at second bus bar 23.

Third bus bar 31 is fitted in third groove 131. Fourth W-phase coil terminal 3114W and first W-phase coil terminal 3111W are provided at third bus bar 31. Connector terminal 31T is provided at third bus bar 31. Connector terminal 31T is connected to connector 102. Second U-phase coil terminal 3212U and second V-phase coil terminal 3212V, and also second W-phase coil terminal 3212W are provided at third bus bar 32. Third bus bar 32 is fitted in third groove 131.

Third bus bar 33 is fitted in third groove 131. Third U-phase coil terminal 3313U, third V-phase coil terminal 3313V, and third W-phase coil terminal 3313W are provided at third bus bar 33.

Fourth bus bar 41 is fitted in fourth groove 141. First U-phase coil terminal 4111U and second U-phase coil terminal 4112U are provided at fourth bus bar 41.

Each bus bar takes a polygonal shape, and a flat plate form. The thickness direction of the bus bar corresponds to the radial direction of the polygon indicated by arrow R. This radial direction corresponds to the direction from the center of the polygon towards the outer circumferential side. Third bus bar 32 serves as a neutral point that connects the U-phase coil, V-phase coil and W-phase coil. Third bus bar 33 serves as a neutral point that connects the U-phase coil, V-phase coil and W-phase coil. Although a three-phase alternating current motor of star connection is shown in FIG. 2, the present invention is not limited thereto, and may be applied to a 3-phase coil motor of delta connection. Furthermore, the present invention is applicable to a rotating electric machine that is another alternating-current motor or direct-current motor configured to connect the coil with a plurality of bus bars.

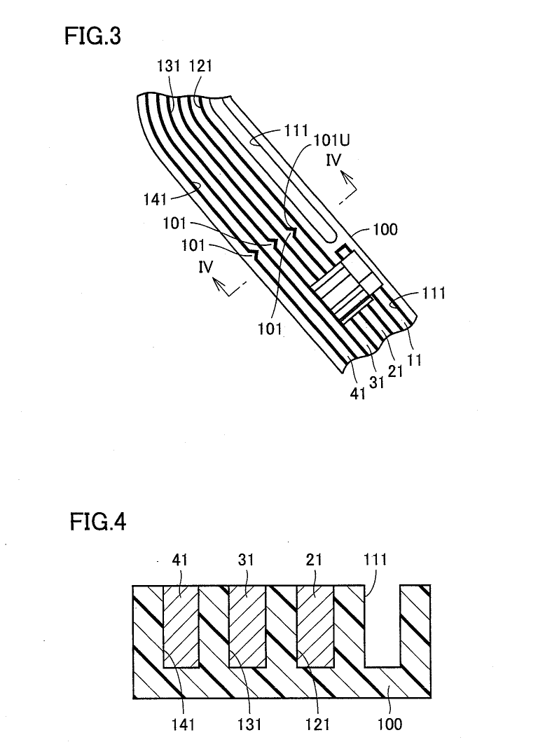

FIG. 3 is a plan view of a rail partially enlarged. Referring to FIG. 3, rail 100 includes first groove 111, second groove 121, third groove 131 and fourth groove 141 extending parallel to each other. Each groove extends in the longitudinal direction (circumferential direction) of rail 100. First bus bar 11 is inserted in first groove 111. Second bus bar 21 inserted in second groove 121. Third bus bar 31 is inserted in third groove 131. Fourth bus bar 41 is inserted in the fourth groove 141. A rib 101 for positioning a bus bar is provided at each groove. A concave 101U to receive rib 101 is provided at each bus bar. Bus bar is configured to be fitted with rib 101.

FIG. 4 is a sectional view taken along arrow IV-IV in FIG. 3. Referring to FIG. 4, first, second, third and fourth grooves 111, 121, 131 and 141 of rectangular shape are provided at rail 100. Each of first groove 111, second groove 121, third groove 131 and fourth groove 141 is configured to have a bottom. Although first, second, third and fourth grooves 111, 121, 131 and 141 are configured to have substantially the same width and depth, the configuration is not limited thereto. The depth and width of first, second, third and fourth grooves 111, 121, 131 and 141 may be modified appropriately depending upon the dimension of the inserted bus bar. Moreover, an insulator or the like may be provided between the bus bar and rail.

Second bus bar 21, third bus bar 31, and fourth bus bar 41 having a width (thickness) substantially equal to that of second groove 121, third groove 131, and fourth groove 141 are fitted in respective grooves. FIG. 4 does not show rib 101 since the cross section thereof is not cut through the site that goes through rib 101.

FIG. 5 is a plan view of a rail according to another aspect. Referring to FIG. 5, second bus bar 21, third bus bar 31 and fourth bus bar 41 differ from the bus bars shown in FIG. 3 in that a concave to receive a rib 101 is not provided at rail 100 of the present embodiment. Second bus bar 21, third bus bar 31, and fourth bus bar 41 are all pushed by rib 101.

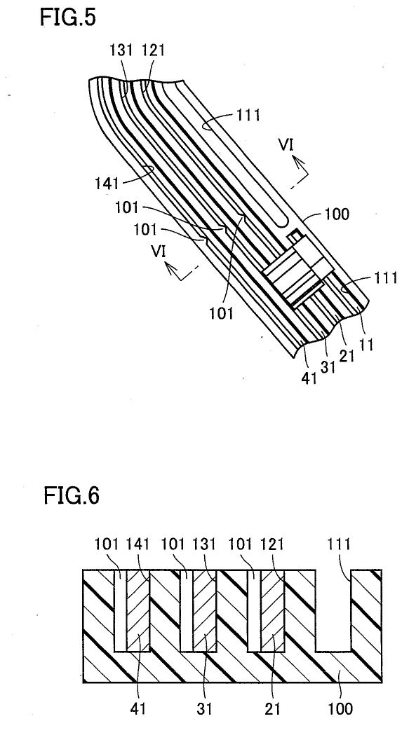

FIG. 6 is a cross sectional view taken along arrow VI-VI of FIG. 5. Referring to FIG. 6, rib 101 extends in the thickness direction (the depth direction of the grove) of rail 100, abutting against second bus bar 21, third bus bar 31 and fourth bus bar 41. Although a rib is not provided at first groove 111 in the present embodiment, a rib may be provided at first groove 111.

Second bus bar 21, third bus bar 31 and fourth bus bar 41 having a smaller width than second groove 121, third groove 131 and fourth groove 141, i.e. more thinner, are fitted in respective grooves. Although the cross section of FIG. 6 is not cut through rib 101, rib 101 at the rear side is shown in the drawing from the gap between each groove and bus bar.

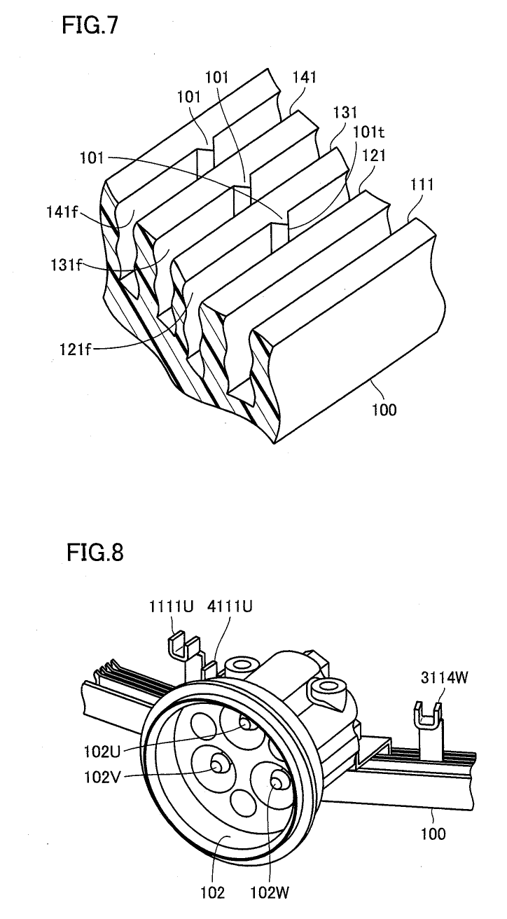

FIG. 7 is a perspective view of a portion of a rail. Referring to FIG. 7, first groove 111, second groove 121, third groove 131 and fourth groove 141 having a predetermined depth and extending along the longitudinal direction are provided at rail 100. At second groove 121, third groove 131 and fourth groove 141, a rib 101 projecting in the radial direction and extending along the axial direction of rail 100 is provided. The shape of rib 101 is not limited to the triangle prism shown in FIG. 7, and another prismatic shape may be employed. Alternatively, a circular column, a semi-circular column, or a semi-elliptical column may be taken.

Rib 101 is provided so as to protrude from side faces 121f, 131f, and 141f defining each groove. Although rib 101 extends in parallel in the axial direction in the present embodiment, the arrangement is not limited thereto. Rib 101 may extend so as to cross the axial direction. Furthermore, the height of rib 101, i.e. the distance from side faces 121f, 131f and 141f to the apex 101t of rib 101, may be, as in the present embodiment, or not be, constant. Rib 101 provided at each groove may be located on the same radius, or located in a random manner instead of on the same radius.

FIG. 8 is a perspective view of a connector. Referring to FIG. 8, a connector 102 is attached to rail 100. Rail 100 and connector 102 may be formed integrally, or may be formed as individual units, and then fastened to each other. U-phase coil terminal 102U, V-phase coil terminal 102V, and W-phase coil terminal 102W are provided in connector 102. U-phase coil terminal 102U is connected to the U-phase coil. V-phase coil terminal 102V is connected to the V-phase coil. W-phase coil terminal 102W is connected to the W-phase coil. When power is supplied from U-phase coil terminal 102U, V-phase coil terminal 102V and W-phase coil terminal 102W, the power is delivered to the U-phase coil, V-phase coil and W-phase coil to cause generation of a magnetic field at each coil. Thus, a rotor constituting the rotating electric machine (motor) rotates.

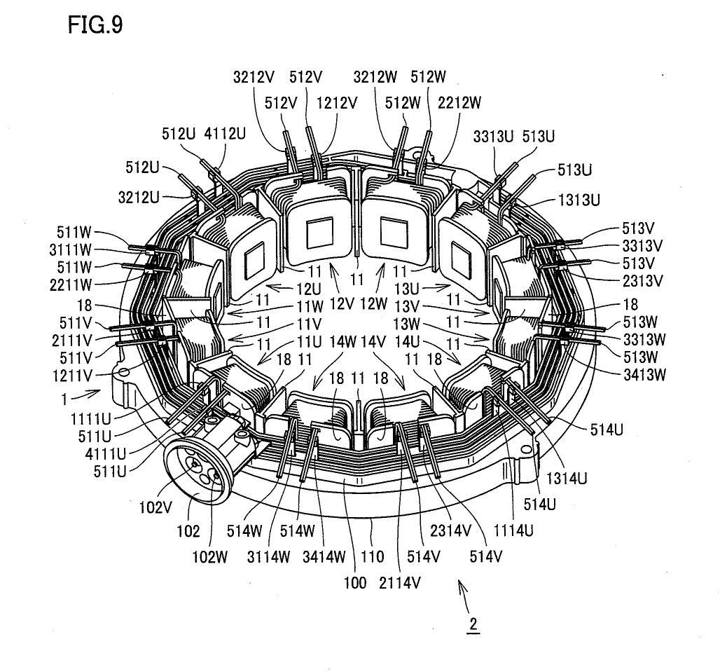

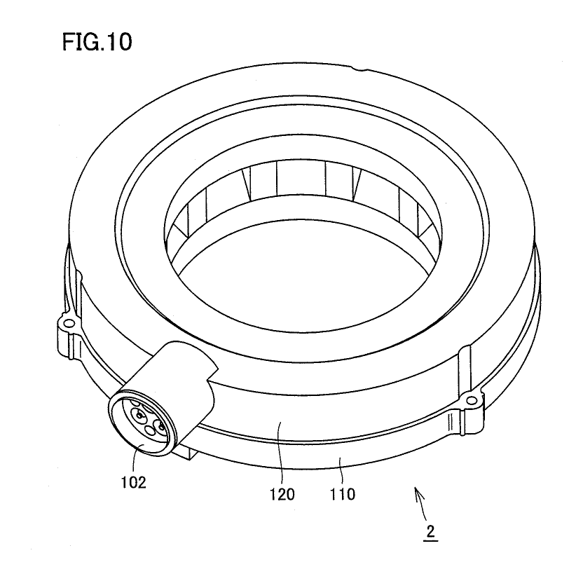

FIG. 9 is a perspective view of a stator employing a terminal module according to the present invention. Referring to FIG. 9, a stator 2 includes a first U-phase coil 11U, a first V-phase coil 11V, a first W-phase coil 11W, a second U-phase coil 12U, a second V-phase coil 12V, a second W-phase coil 12W, a third U-phase coil 13U, a third V-phase coil 13V, a third W-phase coil 13W, a fourth U-phase coil 14U, a fourth V-phase coil 14V and a fourth W-phase coil 14W, arranged along the circumference of the same circle. First U-phase coil 11U is formed having conductive wire 511U wound to the teeth. Conductive wire 511U has one end connected to first U-phase coil terminal 4111U, and the other end connected to first U-phase coil terminal 111U.

First V-phase coil 11 V is formed having conductive wire 511V wound to the teeth. Conductive wire 511V has one end connected to first V-phase coil terminal 1211V, and the other end connected to first V-phase coil terminal 2111V.

First W-phase coil 11W is formed having conductive wire 511W wound to the teeth. Conductive wire 511W has one end connected to first W-phase coil terminal 2111W, and the other end connected to first W-phase coil terminal 3111W.

Second U-phase coil 12U is formed having conductive wire 512U wound to the teeth. Conductive wire 512U has one end connected to second U-phase coil terminal 3212U, and the other end connected to second U-phase coil terminal 4112U.

Second V-phase coil 12V is formed having conductive wire 512V wound to the teeth. Conductive wire 512V has one end connected to second V-phase coil terminal 3212V, and the other end connected to second V-phase coil terminal 1212V.

Second W-phase coil 12W is formed having conductive wire 512W wound to the teeth. Conductive wire 512W has one end connected to second W-phase coil terminal 3212W, and the other end connected to second W-phase coil terminal 2112W.

Third U-phase coil 13U is formed having conductive wire 513U wound to the teeth. Conductive wire 513U has one end connected to third U-phase coil terminal 3313U, and the other end connected to third U-phase coil terminal 1313U.

Third V-phase coil 13V is formed having conductive wire 513V wound to the teeth. Conductive wire 513V has one end connected to third V-phase coil terminal 3313V, and the other end connected to third V-phase coil terminal 2213V.

Third W-phase coil 13W is formed having conductive wire 513W wound to the teeth. Conductive wire 513W has one end connected to third W-phase coil terminal 3313W, and the other end connected to third W-phase coil terminal 3413W.

Fourth U-phase coil 14U is formed having conductive wire 514U wound to the teeth. Conductive wire 514U has one end connected to fourth U-phase coil terminal 4314U, and the other end connected to fourth U-phase coil terminal 1114U.

Fourth V-phase coil 14V is formed having conductive wire 514V wound to the teeth. Conductive wire 514V has one end connected to fourth V-phase coil terminal 2214V, and the other end connected to fourth V-phase coil terminal 2114V.

Fourth W-phase coil 14W is formed having conductive wire 514W wound to the teeth. Conductive wire 514W has one end connected to fourth W-phase coil terminal 3414W, and the other end connected to fourth W-phase coil terminal 3114W.

By virtue of each coil terminal having a concave, configured to receive each conductive wire, connection between a conductive wire and terminal is ensured. Each coil corresponds to a cassette coil. Each coil is formed having a conductive wire wound to the teeth, before being assembled into stator 2. A partition plate 11 is provided between the plurality of coils, serving to ensure insulation between adjacent coils. Rail 100 is attached to a stator core 110 constituting the base member. Stator core 110 is formed of a magnetic material such as an electromagnetic steel plate. Polygonal rail 100 fitted with stator core 110 is held and positioned by base member 110.

FIG. 10 is a perspective view of a stator molded by a mold member. Referring to FIG. 10, the rail and coil located on base member 110 are molded by a mold member 120 formed of resin. Accordingly, the positioning of each coil, as well as insulation between adjacent coils, is ensured. The molding based on resin is not limited to the formation of a mold, as shown in FIG. 10. A configuration of ensuring positioning of each coil may be employed by applying insulating resin such as varnish to the surface of the coil.

Terminal module 1 for a rotating electric machine according to the present invention includes a polygonal rail 100 in which are provided first groove 111, second groove 121, third groove 131, and fourth groove 141 extending in the circumferential direction, and a first bus bar 11 to fourth bus bar 41 of a polygonal shape, fitted in a groove. First to fourth grooves 111, 121, 131 and 141 are arranged in the radial direction of the polygonal shape, spaced apart from each other. The thickness direction of first bus bar 11 to fourth bus bar 41 corresponds to the radial direction of the polygonal shape. First bus bar 11 to fourth bus bar 41 include U-phase to W-phase coil terminals extending axially of the polygon, and connected to the coil. A rib 101 abutting against a bus bar to push the bus bar in the radial direction of the polygonal shape is provided at first groove 111 to fourth groove 141. The terminal module further includes a connector 102 for the output cable, functioning as a terminal block provided at rail 100. Inner circumferential face 105 identified as a flat face against which a cassette coil abuts is located at the inner circumferential side of rail 100. Stator 2 constituting a portion of the rotating electric machine of the present invention includes the foregoing terminal module 1 for a rotating electric machine, first U-phase coil 11U to fourth W-phase coil 14W constituting a cassette coil of concentrated winding, abutting against inner circumferential face 105 of rail 100, and a mold member 120 for molding rail 100 and the cassette coil.

A resin rail 100 formed in a polygonal shape for insulation is employed as a motor terminal module for a hybrid or electric vehicle of the present invention. A plurality of bus bars formed of copper are disposed in resin rail 100, and connected to the coil windings of the motor by terminals functioning as a caulking member, constituting an electrical circuit. In the case of combination with a motor of concentrated winding, the space of back yoke 18 of the coil is used efficiently, allowing downsizing of the motor per se. Furthermore, the accuracy can be improved since the bus bar itself is pressed-formed in a polygonal shape. In addition, the accuracy of rail 100 and the bus bar can be improved, allowing automatic assembling.

The bus bar is secured by virtue of rib 101 in resin rail 100 pushing the bus bar towards the inner wall. In this case, the resin formation of rail 100 is facilitated just by forming the rib in rail 100. By the configuration of pushing the bus bar towards the inner wall side, the protrusion towards the back yoke is reduced to the minimum, allowing downsizing of the motor.

By virtue of the bus bar being secured by the rib, the accuracy is improved, absent of shifting caused by backlash. Thus, automatic assembling can be accommodated.

U-phase coil terminal 102U, V-phase coil terminal 102V and W-phase coil terminal 102W constituting an electrode at the drawout portion of the bus bar are secured by welding or by means of a bolt, and covered with a housing formed of resin to constitute connector 102. A groove form for molding or an O ring can be attached to connector 102 in consideration of molding. Accordingly, direct connection with an external source is allowed. Thus, the number of components such as of the terminal block can be reduced. Furthermore, the position accuracy can be readily improved since the position of the bus bar and terminals is maintained by the housing. Sealing is facilitated in forming the motor with a resin mold, corresponding to reducing the cost and allowing mass production.

Although the space in consideration of tools and/or to ensure the insulating distance is required in the bolt fastening stage by means of a terminal block, the degree of freedom at the connection with a coil can be improved since the terminal portion can be reduced in size by the present configuration.

The present invention is applied to a rotating electric machine of concentrated winding, having arranged a terminal module 1 for a rotating electric machine of a stator core 110 with stacked electromagnetic steel plates. Terminal module 1 for a rotating electric machine is formed in a polygonal shape in association with the number of slots in stator core 110. Connector 102 is formed integrally at the leading end. A coil identified as a cassette coil is fitted in stator core 110, and connection with terminal module 1 for a rotating electric machine is established by caulking. Then, connector 102 is sealed for resin-molding the motor entirely.

Another example based on the configuration of connector 102 as simple conductive terminals is allowed. The shape of the connector housing can be formed integrally with resin molding.

It should be understood that the embodiments disclosed herein are illustrative and non-restrictive in every respect. The scope of the present invention is defined by the terms of the claims, rather than the description above, and is intended to include any modification within the scope and meaning equivalent to the terms of the claims.

### INDUSTRIAL APPLICABILITY

The present invention can be employed in the field of a rotating electric machine incorporated in, for example, a vehicle.

1. A terminal module for a rotating electric machine, comprising:
a rail of a polygonal shape, having a groove extending in a circumferential direction, and
a bus bar of a polygonal shape, fitted in said groove.

2. The terminal module for a rotating electric machine according to claim 1, wherein a plurality of said grooves are arranged spaced apart from each other in a radial direction of the polygonal shape.

3. The terminal module for a rotating electric machine according to claim 1, wherein a thickness direction of said bus bar corresponds to a radial direction of said polygonal shape.

4. The terminal module for a rotating electric machine according to claim 1, wherein said bus bar includes a terminal extending in an axial direction of the polygonal shape, and connected to a coil.

5. The terminal module for a rotating electric machine according to claim 1, wherein a rib is provided at said groove, said rib abutting against said bus bar to push said bus bar in a radial direction of the polygonal shape.

6. The terminal module for a rotating electric machine according to claim 1 further comprising a connector provided at said rail.

7. The terminal module for a rotating electric machine according to claim 1, wherein a flat face abutting against said coil is provided at an inner circumferential face of said rail.

8. A rotating electric machine comprising:
a terminal module for a rotating electric machine defined in claim 7,
said coil of concentrated winding, abutting against the flat face of said rail and
a mold member for molding said rail and said coil.
